(19) United States
(12) Patent Application Publication
(10) Pub. No.: US 2019/0305442 A1
(43) Pub. Date: Oct. 3, 2019

(54) ELECTRIC WIRE WITH TERMINAL

(71) Applicant: Yazaki Corporation, Tokyo (JP)

(72) Inventors: Junya Shinohara, Shizuoka (JP); Kazuhide Takahashi, Shizuoka (JP)

(21) Appl. No.: 16/359,796

(22) Filed: Mar. 20, 2019

(30) Foreign Application Priority Data
Mar. 29, 2018 (JP) 2018-063657

(51) Int. Cl. H01R 4/18

(52) U.S. Cl. CPC H01R 4/185

(57) ABSTRACT

An electric wire with a terminal includes an electric wire including a conductor portion, a terminal connection portion electrically connected to a counterpart terminal, a conductor crimp portion crimped to the conductor portion, and a sheath crimp portion provided separately from the conductor crimp portion and crimped to the insulator portion, in which the terminal connection portion, the conductor crimp portion, and the sheath crimp portion are constituted by a metal plate including a base material and a plated portion on a surface of the base material, and in at least one of the terminal connection portion, the conductor crimp portion, and the sheath crimp portion, the metal plate has an exposed edge portion exposed outside when the metal plate is crimped to the electric wire, and the exposed edge portion has a tapered shape in a cross-section across one main surface and the other main surface of the metal plate.

### CROSS-REFERENCE TO RELATED APPLICATION(S)

The present application claims priority to and incorporates by reference the entire contents of Japanese Patent Application No. 2018-063657 filed in Japan on Mar. 29, 2018.

### BACKGROUND OF THE INVENTION

### 1. Field of the Invention

The present invention relates to an electric wire with a terminal.

### 2. Description of the Related Art

As a conventional solderless terminal provided in a wire harness applied to a vehicle, for example, Japanese Patent No. 6131893 discloses a wire with a terminal including a wire fixing portion in which a terminal metal fitting is fixed to a sheathed wire, a contact portion between a wire conductor and a terminal metal fitting is coated with a corrosion inhibitor, and a sealant is applied to the wire fixing portion.

Incidentally, the wire with a terminal described in Japanese Patent No. 6131893 has room for improvement in inhibiting corrosion while minimizing manufacturing cost.

### SUMMARY OF THE INVENTION

The present invention has been made in view of the above description, and an object of the present invention is to provide an electric wire with a terminal which can inhibit corrosion while minimizing manufacturing cost.

In order to solve the above mentioned problem and achieve the object, an electric wire with a terminal according to one aspect of the present invention includes an electric wire that includes a conductor portion having conductivity, and an insulator portion having an insulating property and covering an outside of the conductor portion; a terminal connection portion that is electrically connected to a counterpart terminal; a conductor crimp portion that is crimped to the conductor portion; and a sheath crimp portion that is provided separately from the conductor crimp portion and crimped to the insulator portion, wherein the terminal connection portion, the conductor crimp portion, and the sheath crimp portion are constituted by a metal plate including a base material and a plated portion on a surface of the base material, and in at least one of the terminal connection portion, the conductor crimp portion, and the sheath crimp portion, the metal plate has an exposed edge portion exposed outside when the metal plate is crimped to the electric wire, and the exposed edge portion has a tapered shape in a cross-section across one main surface and the other main surface of the metal plate.

According to another aspect of the present invention, in the electric wire with the terminal, it is preferable that the exposed edge portion of the conductor crimp portion near the sheath crimp portion and the exposed edge portion located between the conductor crimp portion and the sheath crimp portion have the tapered shape.

According to still another aspect of the present invention, in the electric wire with the terminal, it is preferable that the exposed edge portion of the sheath crimp portion near the conductor crimp portion has the tapered shape.

According to still another aspect of the present invention, in the electric wire with the terminal, it is preferable that he exposed edge portion of the conductor crimp portion near the terminal connection portion has the tapered shape.

According to still another aspect of the present invention, in the electric wire with the terminal, it is preferable that all of the exposed edge portions of the metal plate including all of the terminal connection portion, the conductor crimp portion, and the sheath crimp portion have the tapered shape.

According to still another aspect of the present invention, in the electric wire with the terminal, it is preferable that the tapered shape is defined by a tapered portion provided on at least one of the one main surface and the other main surface in the cross-section.

According to still another aspect of the present invention, in the electric wire with the terminal, it is preferable that the conductor crimp portion is crimped to the conductor portion being in contact with a surface of the one main surface and the other main surface on which the tapered portion is provided.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a partial perspective view illustrating a schematic configuration of an electric wire with a terminal according to an embodiment;

FIG. 2 is a partial plan view illustrating a state in which a solderless terminal of the electric wire with a terminal according to an embodiment is developed;

FIG. 3 is a diagram illustrating an example of a tapered shape;

FIG. 4 is a diagram illustrating a cross-section of an edge portion of a metal plate according to a reference example;

FIG. 5 is a diagram illustrating an example of a positional relationship of an edge portion of the metal plate to a conductor portion which are in a crimped state;

FIG. 6 is a diagram illustrating an example of a positional relationship of the edge portion of the metal plate to the conductor portion in a crimped state;

FIG. 7 is a diagram illustrating another example of the tapered shape;

FIG. 8 is a diagram illustrating an example of a positional relationship of the edge portion of the metal plate to the conductor portion in a crimped state;

FIG. 9 is a diagram illustrating an example of an overlap crimping method; and

FIG. 10 is a diagram illustrating an example of a wrap-around crimping method.

### DETAILED DESCRIPTION OF THE PREFERRED EMBODIMENTS

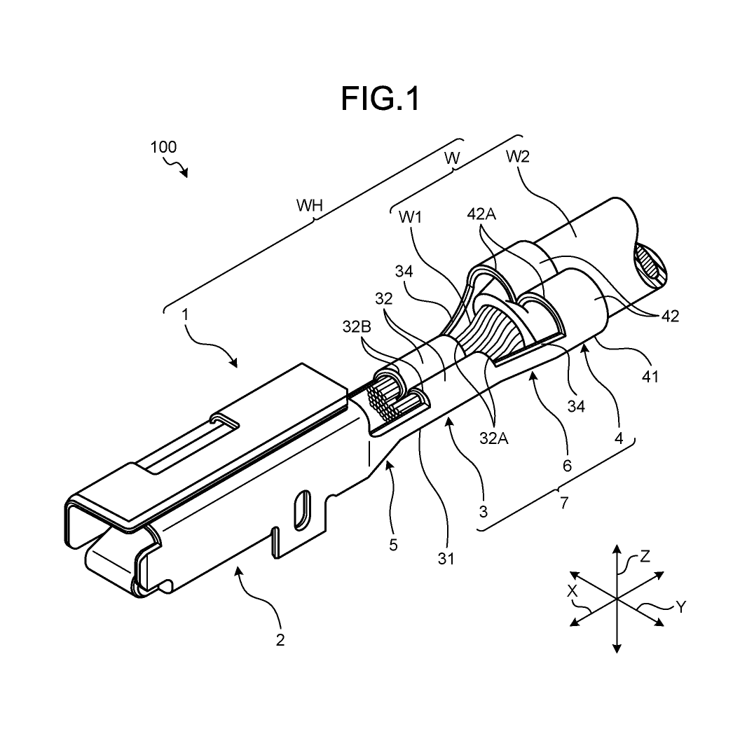

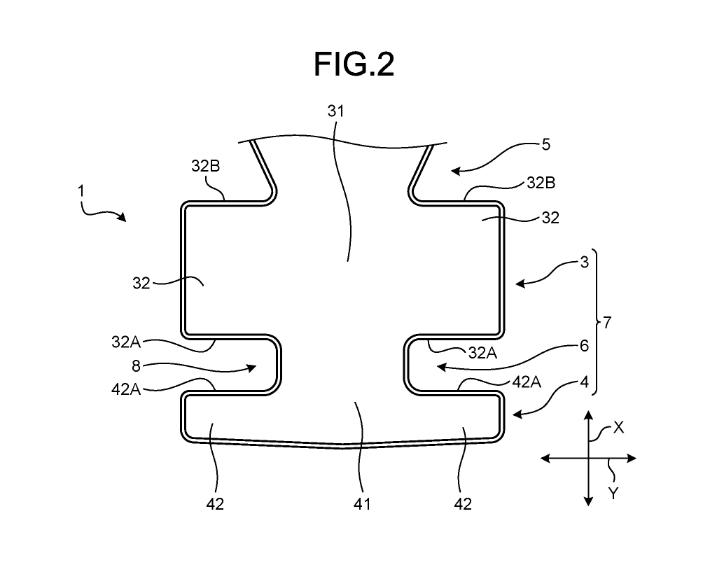

Hereinafter, embodiments according to the present invention will be described in detail with reference to the drawings. It is noted that the present invention is not limited to the embodiments. In addition, component elements in the embodiments described below include component elements readily substituted by a person skilled in the art or substantially the same component elements. FIG. 1 is a partial perspective view illustrating a schematic configuration of an electric wire with a terminal according to an embodiment. FIG. 2 is a partial plan view illustrating a state in which a solderless terminal of the electric wire with a terminal according to an embodiment is developed, in other words, FIG. 2 corresponds to a partial plan view illustrating a state in which a metal plate for the solderless terminal before press molding is expanded.

### Embodiments

An electric wire 100 with a terminal according to the present embodiment illustrated in FIGS. 1 and 2 is a terminal metal fitting applied to a wire harness WH or the like used for, for example, a vehicle. Here, for example, the wire harness WH is an assembly component of a bundle of a plurality of electric wires W used for power supply or signal communication for connection between devices mounted to a vehicle and connects the plurality of electric wires W to the devices with connectors or the like at a time. The wire harness WH includes the electric wires W and a solderless terminals 1 provided at terminals of the electric wires W. Each of the electric wires W includes, for example, a linear conductor portion W1 having conductivity and an insulator portion W2 covering the outside of the conductor portion W1 and having an insulation property. The conductor portion W1 according to the present embodiment is a core wire formed by bundling a plurality of strands of conductive metal, such as copper, copper alloy, aluminum, aluminum alloy, but may be a twisted core wire formed by twisting a plurality of strands. The insulator portion W2 is a wire sheath covering the outer circumferential side of the conductor portion W1. The insulator portion W2 is formed of, for example, an insulating resin material (PP, PVC, cross-linked PE, etc., properly selected considering wear resistance, chemical resistance, heat resistance, or the like). In the electric wire W, at least at one terminal of the conductor portion W1, the insulator portion W2 is peeled off to expose the one terminal of the conductor portion W1 from the insulator portion W2, and the exposed terminal of the conductor portion W1 is provided with the solderless terminal 1. Here, the electric wire W is formed to extend with substantially the same diameter in an extending direction extending linearly, and the conductor portion W1 has a cross-section having a shape (cross-sectional shape in a direction crossing the extending direction) of substantially circle, the insulator portion W2 has a cross-section having a substantially annular shape, and the electric wire W has a cross-section having a substantially circular shape as a whole. In addition, the wire harness WH may further include a grommet, a protector, a fitting, or the like. Hereinafter, the structure of the solderless terminal 1 will be described in detail with reference to the drawings.

In the following description, of a first direction, a second direction, and a third direction which cross each other, the first direction is referred to as an “axial direction X”, the second direction is referred to as a “width direction Y”, and the third direction is referred to as a “height direction Z”. Here, the axial direction X, the width direction Y, and the height direction Z are substantially orthogonal to each other. Typically, the axial direction X corresponds to an extending direction of the electric wire W provided with the solderless terminal 1, and corresponds to a direction in which a terminal connection portion 2, a conductor crimp portion 3, and a sheath crimp portion 4 of the solderless terminal 1 are arranged. The width direction Y and the height direction Z correspond to intersecting directions crossing the axial direction X. Directions used in the following description represent directions in which the respective portions are assembled to each other, unless otherwise specified.

The solderless terminal 1 includes the terminal connection portion 2, the conductor crimp portion 3, the sheath crimp portion 4, a first connection portion 5, and a second connection portion 6, and the solderless terminal 1 is wholly made of a conductive metal, such as copper, a copper alloy, aluminum, an aluminum alloy, or the like. The solderless terminal 1 is formed from, for example, one metal plate punched into a shape having portions corresponding to the portions of the terminal connection portion 2, the conductor crimp portion 3, the sheath crimp portion 4, the first connection portion 5, the second connection portion 6, and the like by pressing and bending, and the respective portions are formed three-dimensionally integrally. In the solderless terminal 1, the terminal connection portion 2, the first connection portion 5, the conductor crimp portion 3, the second connection portion 6, and the sheath crimp portion 4 are connected to each other in this order from one side to the other side of the solderless terminal 1 in the axial direction X. That is, the first connection portion 5 connects the terminal connection portion 2 and the conductor crimp portion 3. The second connection portion 6 connects the conductor crimp portion 3 and the sheath crimp portion 4. The conductor crimp portion 3 is connected to the terminal connection portion 2 and the sheath crimp portion 4 to be spaced apart from each other, via the first connection portion 5 and the second connection portion 6, on both sides of the conductor crimp portion 3 in the axial direction X. Here, the conductor crimp portion 3, the sheath crimp portion 4, and the second connection portion 6 constitute a wire connecting portion 7 for electrically connecting the solderless terminal 1 and the terminal of the electric wire W. The wire connecting portion 7 according to the present embodiment constitutes a so-called open-barrel crimp portion in which the conductor crimp portion 3 is separated from the sheath crimp portion 4 by the second connection portion 6. In the solderless terminal 1, the terminal connection portion 2 and the wire connecting portion 7 are electrically connected via the first connection portion 5, and the terminal connection portion 2 and the conductor portion W1 of the electric wire W are electrically connected via the wire connecting portion 7 and made conductive.

The terminal connection portion 2 is a portion to be electrically connected to a counterpart terminal (not illustrated). The terminal connection portion 2 may have a male terminal shape or a female terminal shape. The terminal connection portion 2 according to the present embodiment is illustrated as having a female terminal shape, and is electrically connected to a counterpart terminal having a male terminal shape.

The conductor crimp portion 3 is a portion crimped and pressed to the conductor portion W1 of the electric wire W and is a portion electrically connected to the conductor portion W1. The conductor crimp portion 3 includes a first base portion 31 as a base portion of the conductor crimp portion and a pair of first barrel piece portions 32 as a barrel piece portion of the conductor crimp portion. The first base portion 31 is a plate-shaped portion on which an end portion of the conductor portion W1 of the electric wire W is mounted. The first base portion 31 has one side in the axial direction X on which the terminal connection portion 2 is connected via the first connection portion 5 and the other side in the axial direction X on which the sheath crimp portion 4 is connected via the second connection portion 6. Here, the first base portion 31 is connected to a second base portion 41 of the sheath crimp portion 4, which is described later, via the second connection portion 6. The first connection portion 5, the first base portion 31, the second connection portion 6, and the second base portion 41 are connected to each other to constitute a bottom plate portion 8 extending in series in the axial direction X. The pair of first barrel piece portions 32 is a portion formed on either side in a width direction Y into a strip shape to extend from the first base portion 31 and crimped and pressed while enclosing the conductor portion W1 between the first barrel piece portions 32 and the first base portion 31. The pair of first barrel piece portions 32 is provided spaced apart from and separate from the terminal connection portion 2 and the sheath crimp portion 4 in the axial direction X. The pair of first barrel piece portions 32 before being crimped to the conductor portion W1 is bent with respect to the first base portion 31 and molded into a substantially U-shape together with the first base portion 31. The first barrel piece portions 32 according to the present embodiment are formed to have a substantially equal distance from a root near the first base portion 31 to an end so that the first barrel piece portions 32 crimped to the conductor portion W1 do not overlap each other.

The sheath crimp portion 4 is a portion crimped and pressed to the insulator portion W2 of the electric wire W. The sheath crimp portion 4 includes the second base portion 41 as a base portion of the sheath crimp portion and a pair of second barrel piece portions 42 as a barrel piece portion of the sheath crimp portion. The second base portion 41 is a plate-shaped portion on which an end portion of the insulator portion W2 of the electric wire W is mounted. As described above, the second base portion 41 has one side in the axial direction X on which the first base portion 31 of the conductor crimp portion 3 is connected via the second connection portion 6. As described above, the second base portion 41 forms the bottom plate portion 8 together with the first connection portion 5, the first base portion 31, and the second connection portion 6. The pair of second barrel piece portions 42 is a portion formed on either side in a width direction Y into a strip shape to extend from the second base portion 41 and crimped and pressed while enclosing the insulator portion W2 between the second barrel piece portions 42 and the second base portion 41. The pair of second barrel piece portions 42 is provided spaced apart from and separate from the sheath crimp portion 4 in the axial direction X. That is, the pair of second barrel piece portions 42 is provided separate from the pair of first barrel piece portions 32. The pair of second barrel piece portions 42 before being crimped to the insulator portion W2 is bent with respect to the second base portion 41 and molded into a substantially U-shape together with the second base portion 41. The second barrel piece portions 42 according to the present embodiment are formed to have a substantially equal distance from a root near the second base portion 41 to an end so that the second barrel piece portions 42 crimped to the insulator portion W2 do not overlap each other.

The solderless terminal 1 according to the present embodiment configured as described above is constituted by a metal plate including a base material and a plated portion on a surface of the base material. Therefore, the terminal connection portion 2, the conductor crimp portion 3, and the sheath crimp portion 4 are constituted by the metal plate described above. Furthermore, in at least one of the terminal connection portion 2, the conductor crimp portion 3, and the sheath crimp portion 4, the metal plate has an exposed edge portion, and the exposed edge portion has a tapered shape in a cross-section across one main surface and the other main surface of the metal plate. The exposed edge portion is a portion exposed outside when the metal plate is crimped to the electric wire W. The terminal connection portion 2, the conductor crimp portion 3, and the sheath crimp portion 4 are close to the conductor portion W1. Therefore, as described later, corrosion is inhibited by forming the exposed edge portion of the metal plate into a tapered shape in at least one of the terminal connection portion 2, the conductor crimp portion 3, and the sheath crimp portion 4. In this example, as illustrated in FIG. 2, on the one main surface of the solderless terminal 1 before being crimped to the electric wire W, any of exposed edge portions 32A and 32B of the first barrel piece portion 32 and exposed edge portions 42A of the second barrel piece portion 42 has a tapered shape. Such a tapered shape can be achieved by making an edge portion of a metal plate before being crimped as illustrated in FIG. 2 flat by press working.

In FIG. 1, the exposed edge portions 32A of the conductor crimp portion 3 near the sheath crimp portion 4, exposed edge portions 34 located between the conductor crimp portion 3 and the sheath crimp portion 4, the exposed edge portions 42A of the sheath crimp portion 4 near the conductor crimp portion 3, and the exposed edge portions 32B of the conductor crimp portion 3 near the terminal connection portion 2 have a tapered shape. The exposed edge portions 32A and the exposed edge portions 34, each of which is close to the conductor portion W1, are formed into the tapered shape, and corrosion of the conductor portion W1 can be inhibited. A portion of the conductor portion W1 close to the exposed edge portion 32A and the exposed edge portion 34 is a path through which current always flows between the electric wire W and the terminal connection portion 2. Therefore, it is important to inhibit corrosion of this portion. The exposed edge portions 42A are close to the conductor portion W1 although the insulator portion W2 is interposed therebetween. Therefore, the exposed edge portions 42A are each formed into the tapered shape to inhibit the corrosion of the conductor portion W1. Since each of the exposed edge portions 32B close to the conductor portion W1 is formed into the tapered shape, the corrosion of the conductor portion W1 can be inhibited. Since no resin for inhibiting corrosion is used to change the shape of each of the exposed edge portions, it is possible to inhibit corrosion while minimizing the manufacturing cost.

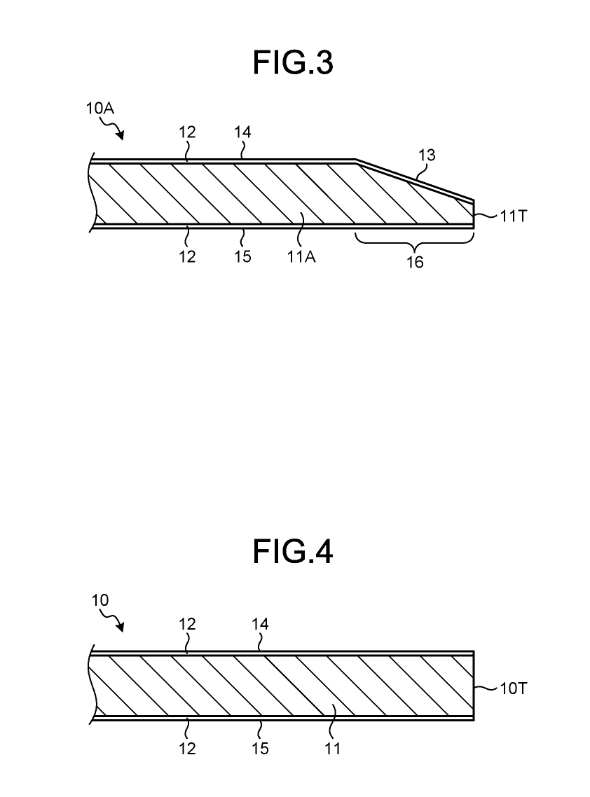

FIG. 3 is a diagram illustrating an example of the tapered shape. FIG. 3 is a diagram illustrating a cross-section of an edge portion of the metal plate. FIG. 3 is a cross-sectional view across the one main surface and the other main surface of the metal plate. As illustrated in FIG. 3, a metal plate 10A constituting the solderless terminal 1 includes a base material 11A and plated portions 12 on the surfaces of the base material 11A, that is, on one main surface 14 and the other main surface 15. The metal plate 10A has an end surface 11T from which the base material 11A is exposed. As illustrated in FIG. 3, in the metal plate 10A, the one main surface 14 has a tapered portion 13. This tapered portion 13 defines an exposed edge portion 16 to have a tapered shape. The tapered portion 13 may have a flat shape or a curved shape. Furthermore, for example, when the material of the base material 11A is copper, the material of each of the plated portion 12 may be, for example, zinc or nickel and tin.

FIG. 4 is a diagram illustrating a cross-section of an edge portion of a metal plate according to a reference example. As illustrated in FIG. 4, a metal plate 10 includes a base material 11 and plated portions 12 on the surfaces of the base material 11. As illustrated in FIG. 4, the metal plate 10 according to the reference example has a thickness constant toward an end surface 10T and does not have a tapered shape. Therefore, as illustrated in FIG. 3, the area of the base material 11A exposed from the end surface 11T of the metal plate 10A having the tapered shape at the exposed edge portion 16 is smaller than that in the reference example of FIG. 4.

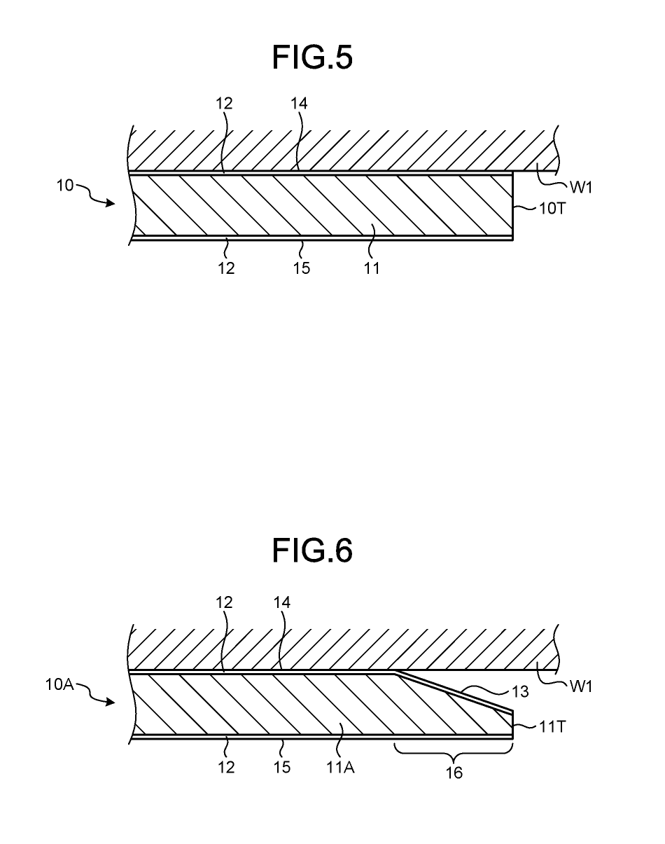

FIG. 5 is a diagram illustrating an example of a positional relationship of the end surface 10T of the metal plate illustrated in FIG. 4 to a conductor portion W1 which are in a crimped state. As illustrated in FIG. 5, in the crimped state, the end surface 10T and the conductor portion W1 are close to each other. Here, consider a case where the ionization tendency of the base material 11 is different from the ionization tendency of the conductor portion W1. For example, consider a case where the material of the base material 11 is copper and the material of the conductor portion W1 is aluminum. In this case, when water enters between the base material 11 and the conductor portion W1, the conductor portion W1 may be corrode (galvanic corrosion) due to a difference in ionization tendency.

In contrast, in a case of the metal plate 10A illustrated in FIG. 3, the area of the base material 11A exposed from the end surface 11T is smaller than that in the reference example of FIG. 4 Therefore, when the metal plate 10A illustrated in FIG. 3 is used for the electric wire 100 with a terminal, the corrosion of the conductor portion W1 is inhibited as compared with the reference example of FIG. 4, even when water enters between the base material 11A and the conductor portion W1. FIG. 6 is a diagram illustrating an example of a positional relationship of the end surface 11T of the metal plate illustrated in FIG. 3 to a conductor portion W1 which are in a crimped state. As illustrated in FIG. 6, in the crimped state, the area of a base material 11A exposed from the end surface 11T of the metal plate 10A is smaller than that in the reference example of FIG. 5. Therefore, for example, even when water enters between the base material 11A, the material of which is copper and the conductor portion W1, the material of which is aluminum, corrosion of the conductor portion W1 can be inhibited as compared with the case of FIG. 5. Moreover, since no resin is used, it is possible to inhibit corrosion while minimizing the manufacturing cost. Occurrence of the corrosion of the conductor portion W1 may be caused when the ionization tendency of the base material 11A is different from the ionization tendency of the conductor portion W1, and is not limited to the case where the material of the base material 11A is copper and the material of the conductor portion W1 is aluminum.

Furthermore, in FIG. 6, a surface provided with a tapered portion 13 is crimped to the conductor portion W1 being in contact with the surface. Therefore, the distance between the end surface 11T and the conductor portion W1 can be secured, and even when water enters between the base material 11A and the conductor portion W1, the possibility of corrosion of the conductor portion W1 can be reduced in the case of FIG. 6, as compared with the case of FIG. 5.

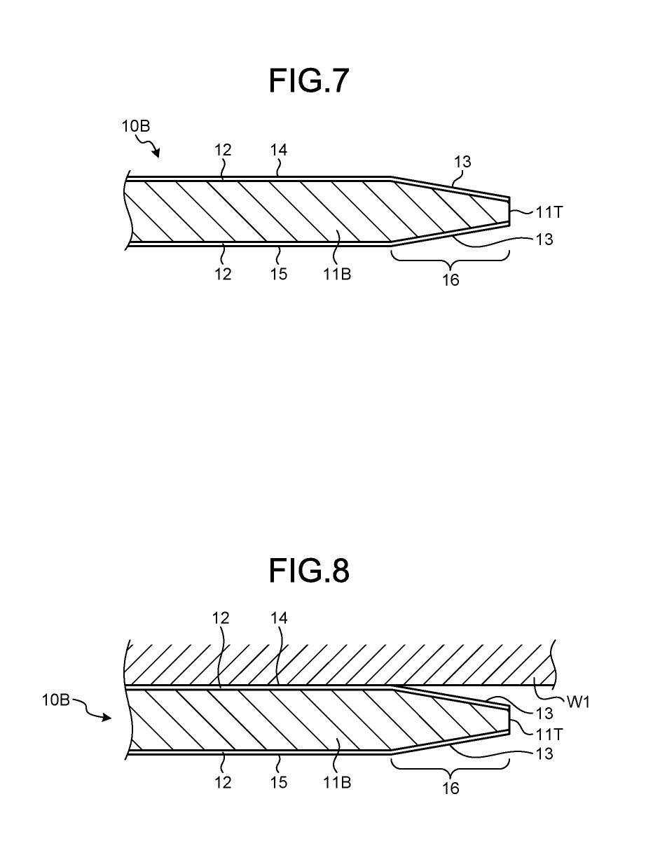

The tapered portion 13 is desirably provided on at least one of the one main surface 14 and the other main surface 15 of the metal plate, and may be provided on both of the one main surface 14 and the other main surface 15 of the metal plate. FIG. 7 is a diagram illustrating another example of the tapered shape. FIG. 7 is a diagram illustrating a cross-section of an edge portion of a metal plate. FIG. 7 is a cross-sectional view across one main surface 14 and the other main surface 15 of the metal plate. As illustrated in FIG. 7, a metal plate 10B constituting a solderless terminal 1 includes a base material 11B and plated portions 12 on the surfaces of the base material 11B, that is, on one main surface 14 and the other main surface 15. The metal plate 10B has an end surface 11T from which the base material 11B is exposed. As illustrated in FIG. 7, in the metal plate 10B, both of the one main surface 14 and the other main surface 15 have a tapered portion 13. This tapered portion 13 defines an exposed edge portion 16 to have a tapered shape. As illustrated in FIG. 7, the area of the base material 11B exposed from the end surface 11T of the metal plate 10B having the tapered shape at the exposed edge portion 16 is smaller than that of the reference example of FIG. 4. Therefore, when the metal plate 10B illustrated in FIG. 7 is used for the electric wire 100 with a terminal, the corrosion of the conductor portion W1 is inhibited as compared with the reference example of FIG. 4, even when water enters between the base material 11B and the conductor portion W1.

FIG. 8 is a diagram illustrating an example of a positional relationship of the end surface 11T of the metal plate 10B illustrated in FIG. 7 to a conductor portion W1 which are in a crimped state. As illustrated in FIG. 8, in the crimped state, the area of the base material 11B exposed from the end surface 11T of the metal plate 10B is smaller than that in the reference example of FIG. 5. Therefore, for example, even when water enters between the base material 11B, the material of which is copper and the conductor portion W1, the material of which is aluminum, the corrosion of the conductor portion W1 can be inhibited in the case of FIG. 8, as compared with the case of FIG. 5. Furthermore, in FIG. 8, a surface provided with a tapered portion 13 is crimped to the conductor portion W1 being in contact with the surface. Therefore, the distance between the end surface 11T and the conductor portion W1 can be secured, and even when water enters between the base material 11B and the conductor portion W1, the possibility of corrosion of the conductor portion W1 can be reduced in the case of FIG. 8, as compared with the case of FIG. 5. Moreover, since no resin is used, it is possible to lower the possibility of corrosion while minimizing the manufacturing cost.

On the one main surface 14 of the solderless terminal 1 before being crimped to the electric wire W, all or some of the exposed edge portions 32A and 32B of the first barrel piece portion 32 and the exposed edge portion 42A of the second barrel piece portion 42 may have a tapered shape. When the exposed edge portions 32A and 32B and the exposed edge portions 42A have a tapered shape, the area of the base material 11A or 11B exposed from the end surface 11T is smaller than those of the exposed edge portions 32A and 32B and exposed edge portions 42A having no tapered shape. Therefore, even when water enters between the base material 11A or 11B and the conductor portion W1, the corrosion of the conductor portion W1 can be inhibited, as compared with the above-mentioned reference example. Moreover, since no resin is used, it is possible to inhibit corrosion while minimizing the manufacturing cost.

As described above with reference to FIG. 1, the exposed edge portion 32A of the conductor crimp portion 3 near the sheath crimp portion 4 and the exposed edge portion 34 located between the conductor crimp portion 3 and the sheath crimp portion 4 have a tapered shape. The exposed edge portions 32A and the exposed edge portions 34, each of which is close to the conductor portion W1, are formed into the tapered shape, and corrosion of the conductor portion W1 can be inhibited. Moreover, since no resin is used, it is possible to inhibit corrosion while minimizing the manufacturing cost. Particularly, a portion of the conductor portion W close to the exposed edge portion 32A and the exposed edge portion 34 is a path through which current always flows between the electric wire W and the terminal connection portion 2. Therefore, it is important to inhibit corrosion of this portion.

Furthermore, the exposed edge portion 42A of the sheath crimp portion 4 near the conductor crimp portion 3 had a tapered shape. The exposed edge portion 42A is close to the conductor portion W1 although the insulator portion W2 is interposed therebetween. Therefore, the exposed edge portion 42A is formed into the tapered shape to inhibit the corrosion of the conductor portion W1. Moreover, since no resin is used, it is possible to inhibit corrosion while minimizing the manufacturing cost.

The exposed edge portion 32B of the conductor crimp portion 3 near the terminal connection portion 2 has a tapered shape. Since the exposed edge portion 32B close to the conductor portion W1 is formed into the tapered shape, the corrosion of the conductor portion W1 can be inhibited. Moreover, since no resin is used, it is possible to inhibit corrosion while minimizing the manufacturing cost.

All exposed edge portions of the metal plate including all of the terminal connection portion 2, the conductor crimp portion 3, and the sheath crimp portion 4 are formed into a tapered shape, and it is possible to perform processing for forming the tapered shape at a time. Therefore, it is possible to inhibit corrosion while minimizing the manufacturing cost due to an increase in the number of processing steps.

As described above, the tapered shape of the exposed edge portions of the metal plate are defined by the tapered portion 13 provided on at least one of the one main surface 14 and the other main surface 15, in a cross-section across the one main surface 14 and the other main surface 15 of the metal plate. The tapered portion 13 can be achieved by making the edge portion of the metal plate before crimping flat in the press working, and processing is facilitated.

Furthermore, as described with reference to FIGS. 6 and 8, the conductor crimp portion 3 is crimped to the conductor portion W1 being in contact with a surface provided with the tapered portion 13 of the one main surface 14 and the other main surface 15. Therefore, the distance between the end surface 11T and the conductor portion W1 can be secured, and even when water enters between the base material 11A or 11B and the conductor portion W1, the possibility of corrosion of the conductor portion W1 can be reduced in the case of FIGS. 6 and 8, as compared with the case of FIG. 5.

### MODIFICATIONS

Note that the solderless terminal with a terminal according to the embodiments of the present invention is not limited to the above embodiments, and various changes and modifications may be made within the scope of claims.

The pair of first barrel piece portions 32 and the pair of second barrel piece portions 42 described above may be formed to overlap each other when being crimped to the conductor portion W1 or either one of a distance from a root on the side of the first base portion 31 to an end and a distance from a root on the side of the second base portion 41 to an end may be formed to be longer than the other.

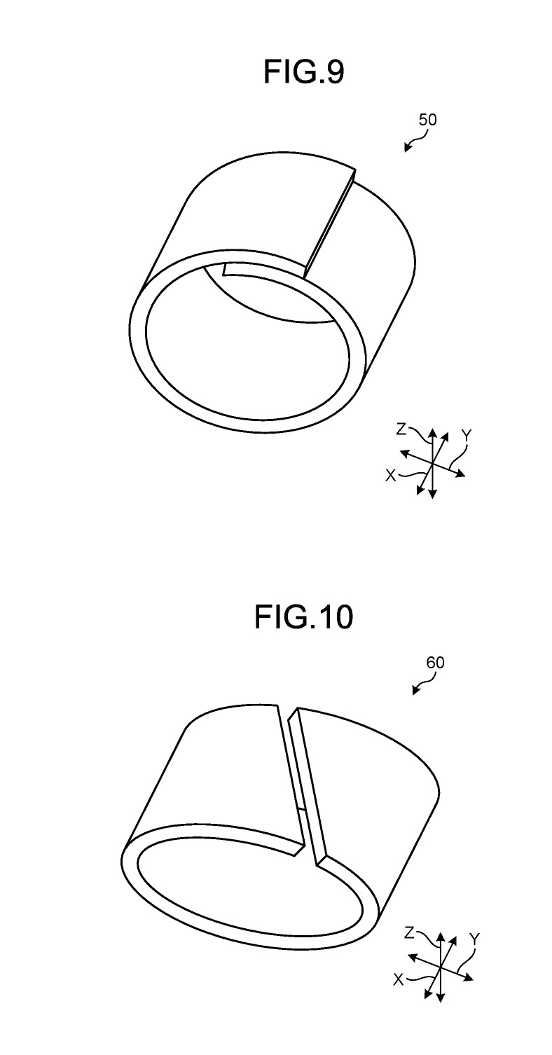

FIG. 1 illustrates a so-called B-shaped crimp in which the pair of first barrel piece portions 32 and the pair of second barrel piece portions 42 are curved toward the center portion so that the end portions of the barrel piece portions bite into the wire and crimped into a B-shape. The crimping method is not limited to this method and another crimping method may be used. That is, for example, as illustrated in FIG. 9, the crimping method may use an overlap crimp in which end portions of a pair of barrel piece portions 50 overlapping each other are crimped. Furthermore, as illustrated in FIG. 10, the crimping method may use a wrap-around crimp in which oblique end portions of a pair of barrel piece portions 60 closely positioned are crimped. In FIGS. 9 and 10, the corresponding pairs of barrel piece portions are illustrated, and illustration of wires is omitted.

The electric wire with a terminal according to the present embodiment includes a wire including a conductor portion and an insulator portion, a terminal connection portion electrically connected to a counterpart terminal, a conductor crimp portion crimped to the conductor portion, and a sheath crimp portion provided separately from the conductor crimp portion and crimped to the insulator portion. The terminal connection portion, the conductor crimp portion, and the sheath crimp portion are constituted by a metal plate including a base material and a plated portion on a surface of the base material. In at least one of the terminal connection portion, the conductor crimp portion, and the sheath crimp portion, the metal plate has an exposed edge portion exposed outside when the metal plate is crimped to the wire, and the exposed edge portion has a tapered shape in a cross-section across one main surface and the other main surface. Therefore, corrosion can be inhibited while minimizing manufacturing cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric wire with a terminal comprising:
an electric wire that includes a conductor portion having conductivity, and an insulator portion having an insulating property and covering an outside of the conductor portion;
a terminal connection portion that is electrically connected to a counterpart terminal;
a conductor crimp portion that is crimped to the conductor portion; and
a sheath crimp portion that is provided separately from the conductor crimp portion and crimped to the insulator portion, wherein
the terminal connection portion, the conductor crimp portion, and the sheath crimp portion are constituted by a metal plate including a base material and a plated portion on a surface of the base material, and
in at least one of the terminal connection portion, the conductor crimp portion, and the sheath crimp portion, the metal plate has an exposed edge portion exposed outside when the metal plate is crimped to the electric wire, and the exposed edge portion has a tapered shape in a cross-section across one main surface and the other main surface of the metal plate.

2. The electric wire with a terminal according to claim 1, wherein
the exposed edge portion of the conductor crimp portion near the sheath crimp portion and the exposed edge portion located between the conductor crimp portion and the sheath crimp portion have the tapered shape.

3. The electric wire with a terminal according to claim 1, wherein
the exposed edge portion of the sheath crimp portion near the conductor crimp portion has the tapered shape.

4. The electric wire with a terminal according to claim 2, wherein
the exposed edge portion of the sheath crimp portion near the conductor crimp portion has the tapered shape.

5. The electric wire with a terminal according to claim 1, wherein
the exposed edge portion of the conductor crimp portion near the terminal connection portion has the tapered shape.

6. The electric wire with a terminal according to claim 2, wherein
the exposed edge portion of the conductor crimp portion near the terminal connection portion has the tapered shape.

7. The electric wire with a terminal according to claim 3, wherein
the exposed edge portion of the conductor crimp portion near the terminal connection portion has the tapered shape.

8. The electric wire with a terminal according to claim 1, wherein
all of the exposed edge portions of the metal plate including all of the terminal connection portion, the conductor crimp portion, and the sheath crimp portion have the tapered shape.

9. The electric wire with a terminal according to claim 2, wherein
all of the exposed edge portions of the metal plate including all of the terminal connection portion, the conductor crimp portion, and the sheath crimp portion have the tapered shape.

10. The electric wire with a terminal according to claim 3, wherein
all of the exposed edge portions of the metal plate including all of the terminal connection portion, the conductor crimp portion, and the sheath crimp portion have the tapered shape.

11. The electric wire with a terminal according to claim 5, wherein
all of the exposed edge portions of the metal plate including all of the terminal connection portion, the conductor crimp portion, and the sheath crimp portion have the tapered shape.

12. The electric wire with a terminal according to claim 1, wherein
the tapered shape is defined by a tapered portion provided on at least one of the one main surface and the other main surface in the cross-section.

13. The electric wire with a terminal according to claim 2, wherein
the tapered shape is defined by a tapered portion provided on at least one of the one main surface and the other main surface in the cross-section.

14. The electric wire with a terminal according to claim 3, wherein
the tapered shape is defined by a tapered portion provided on at least one of the one main surface and the other main surface in the cross-section.

15. The electric wire with a terminal according to claim 5, wherein
the tapered shape is defined by a tapered portion provided on at least one of the one main surface and the other main surface in the cross-section.

16. The electric wire with a terminal according to claim 8, wherein
the tapered shape is defined by a tapered portion provided on at least one of the one main surface and the other main surface in the cross-section.

17. The electric wire with a terminal according to claim 12, wherein
the conductor crimp portion is crimped to the conductor portion being in contact with a surface of the one main surface and the other main surface on which the tapered portion is provided.
